(19) United States
(12) Patent Application Publication
(10) Pub. No.: US 2007/0041408 A1
(43) Pub. Date: Feb. 22, 2007

(54) Router for supporting ima function in a mobile communication network

(75) Inventor: Tay Wook Kang, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Starcom Korea Limited, Icheon-si (KR)

(21) Appl. No.: 10/556,133

(22) PCT Filed: Jun. 2, 2004
(86) PCT No.: PCT/KR04/01308

§ 371 Date: Aug. 29, 2006

(30) Foreign Application Priority Data
Jun. 2, 2003 (KR) 10-2003-0035278

(51) Int. Cl. H04J 3/04

(52) U.S. Cl. 370/536

(57) ABSTRACT

The present invention relates to a router supporting an Inverse Multiplexing over ATM (IMA) function in a mobile communication network. The router in accordance with the present invention comprises a CPU for converting a plurality of Ethernet packets inputted from network processors connected to subscribers into ATM cells and outputting the converted ATM cells, and for converting a plurality of ATM cells inputted from the CPU into Ethernet packets and disturbing the converted Ethernet packets to the network processors; an ATM multiplexer/demultiplexer connected to the CPU for multiplexing or demultiplexing the ATM cells; an IMA processor connected to the ATM multiplexer/demultiplexer for converting the ATM cells inputted from the ATM multiplexer/demultiplexer into Pulse Code Modulation (PCM) packets and grouping the PCM packets, and for converting the grouped PCM packets into ATM cells and outputting the converted ATM cells to the ATM multiplexer/demultiplexer, and a line interface unit for transmitting the grouped PCM packets to a general network via a line (e.g., E1 or T1) and outputting grouped PCM packets inputted from the general network to the IMA processor. Because the router of the present invention incorporates the CSU/DSU and IMA functions therein, data services can be provided in a bandwidth broader than the E1/T1 bandwidth.

### TECHNICAL FIELD

The present invention relates to a router supporting an Inverse Multiplexing over ATM (IMA) function in a mobile communication network, and more particularly to a router, which comprises a Channel Service Unit/Digital Service Unit (CSU/DSU) function and an IMA function implemented thereinto, configured to provide subscribers with data services in a bandwidth broader than the E1/T1 bandwidth and allows the architecture of the mobile communication network to be simplified.

### BACKGROUND ART

As shown in FIG. 1, a typical mobile communication network comprises a subscriber terminal 1, a plurality of hubs 2, a router 3 connected to plurality of hubs 2 via the Ethernet for performing a data routing function, and a CSU/DSU 4 connected to router 3 in compliance with the V.36 standard specification for converting Ethernet data to E1/T1 data for transmission to a general network 5. However, the above-mentioned communication network has a certain drawback in that the implementation of the entire network is costly due to the necessity of separate hardware implementations of routers and CSU/DUS. Further, in such communication network, excessive efforts must be exerted for the operation and maintenance of the network. In addition, the routers in the conventional communication network could not support data services requiring a bandwidth broader than an E1/T1 bandwidth. These limitations make it difficult to provide high-quality data services and reduces the efficiency of the mobile communication network.

### DISCLOSURE OF THE INVENTION

Accordingly, the present invention is provided to solve the above problems associated with the prior art. The objective of the present invention is to provide a router supporting an IMA function in a mobile communication network which can provide subscribers with data services in a bandwidth broader than the E1/T1 bandwidth, thereby improving the service quality and allowing the architecture of the mobile communication network to be simplified.

In accordance with an embodiment of the present invention, a router for supporting an IMA function in the mobile communication network is provided. The router comprises: a CPU for converting a plurality of Ethernet packets inputted from network processors connected to subscribers into ATM cells and outputting the converted ATM cells, and for converting a plurality of ATM cells inputted from said CPU into Ethernet packets and distributing the converted Ethernet packets to the network processors; an ATM multiplexer/demultiplexer connected to said CPU for multiplexing or demultiplexing the ATM cells; an IMA processor connected to said ATM multiplexer/demultiplexer for converting the ATM cells inputted from said ATM multiplexer/demultiplexer into Pulse Code Modulation (PCM) packets and grouping the PCM packets, and for converting the grouped PCM packets into ATM cells and outputting the converted ATM cells to said ATM multiplexer/demultiplexer; and a line interface unit for transmitting the grouped PCM packets to a general network via a line (e.g., E1 or T1) and outputting grouped PCM packets inputted from the general network to said IMA processor.

### BRIEF DESCRIPTION OF DRAWINGS

The above objective and features of the present invention will become more apparent from the following description of the preferred embodiments provided in conjunction with the accompanying drawings.

FIG. 1 is a view showing a configuration of a general mobile communication network.

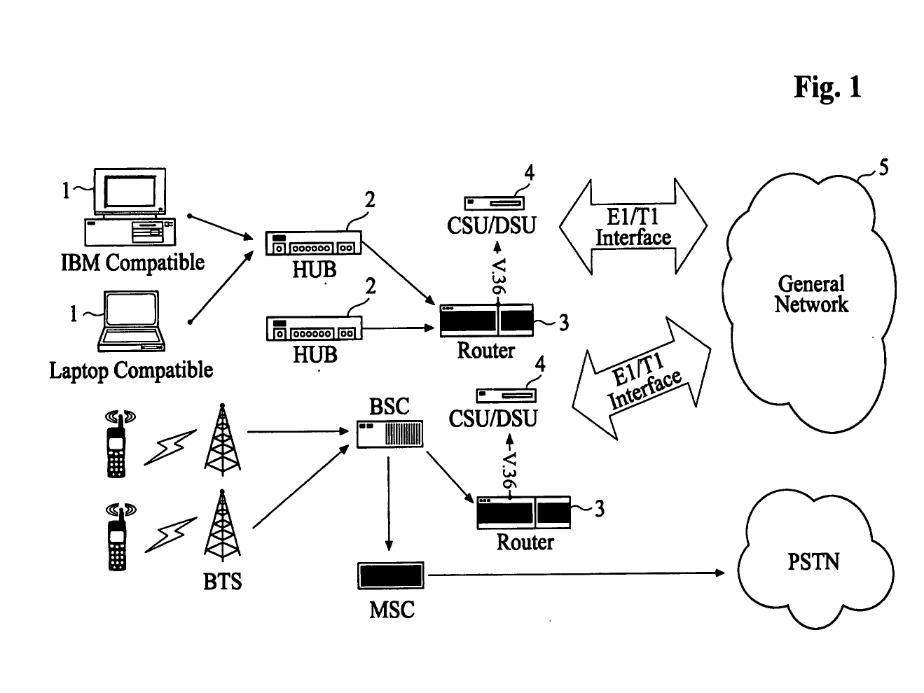

FIG. 2 is a view showing a configuration of a mobile communication network according to the present invention.

FIG. 3 is a functional block diagram showing an embodiment of a router supporting an IMA function in a mobile communication network according to the present invention.

FIG. 4 is a diagram for explaining a round-robin scheme at an IMA processor of a router supporting an IMA function as shown in FIG. 3.

### BEST MODE FOR CARRYING OUT THE INVENTION

A router supporting an IMA function in a mobile communication network according to an embodiment of the present invention will be described below in detail with reference to the accompanying drawings.

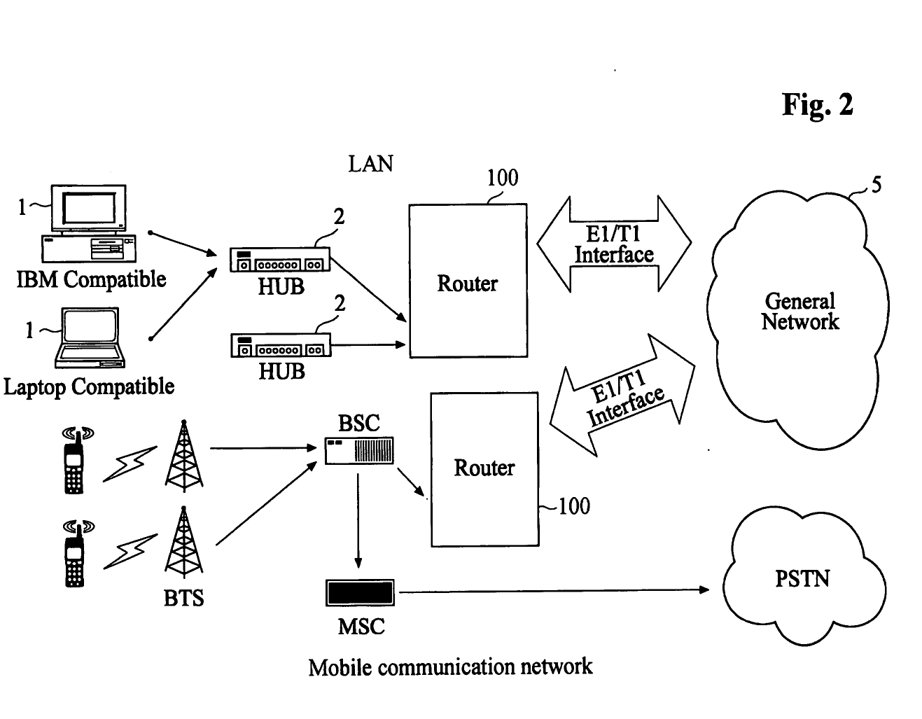

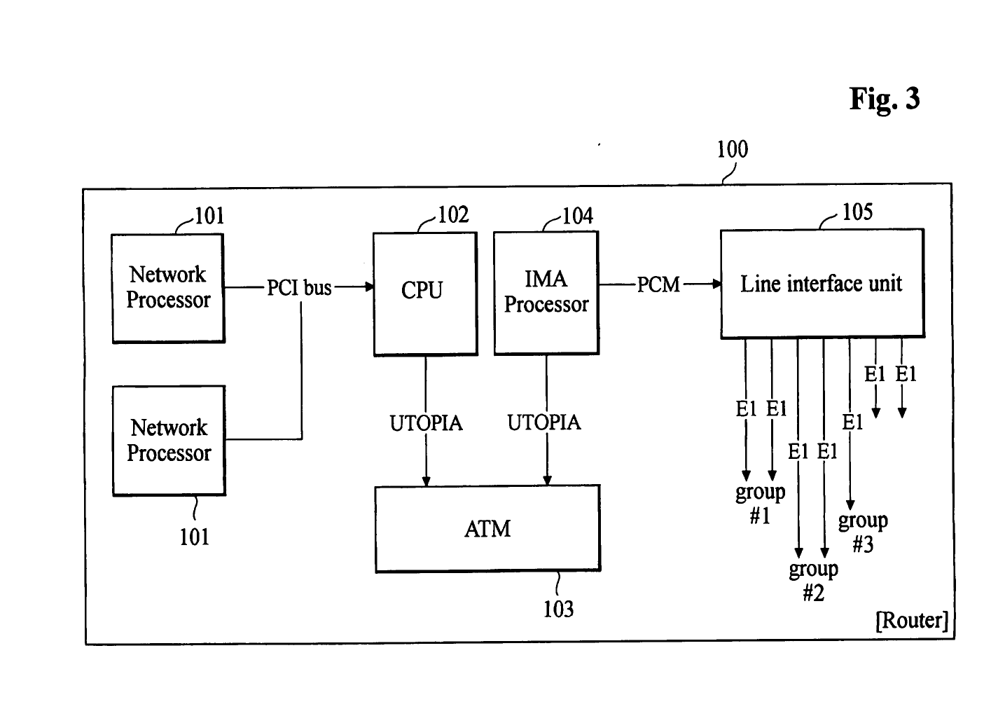

FIG. 2 is a view showing a configuration of a mobile communication network according to the present invention. FIG. 3 is a functional block diagram showing an embodiment of a router supporting an IMA function in a mobile communication network according to the present invention. Router 100 supporting an IMA function in a mobile communication network according to an embodiment of the present invention comprises network processors 101, a CPU 102, an ATM multiplexer/demultiplexer 103, an IMA processor 104, and a line interface unit 105.

CPU 102 receives a plurality of Ethernet packets from network processors 101 connected to the subscribers and converts them into ATM cells. CPU 102 outputs the converted ATM cells to ATM multiplexer/demultiplexer 103. CPU 102 receives a plurality of ATM cells from ATM multiplexer/demultiplexer 103, converts them into Ethernet data, and distributes the converted Ethernet data to network processors 101.

ATM multiplexer/demultiplexer 103 is connected to CPU 102 through a Utopia bus. ATM multiplexer/demultiplexer 103 multiplexes the plurality of ATM cells inputted from CPU 102 to produce multiplexed outputs, and the multiplexed outputs are supplied to IMA processor 104. ATM multiplexer/demultiplexer 103 demultiplexes the ATM cells inputted from IMA processor 104 to produce a demultiplexed output which is supplied to CPU 102.

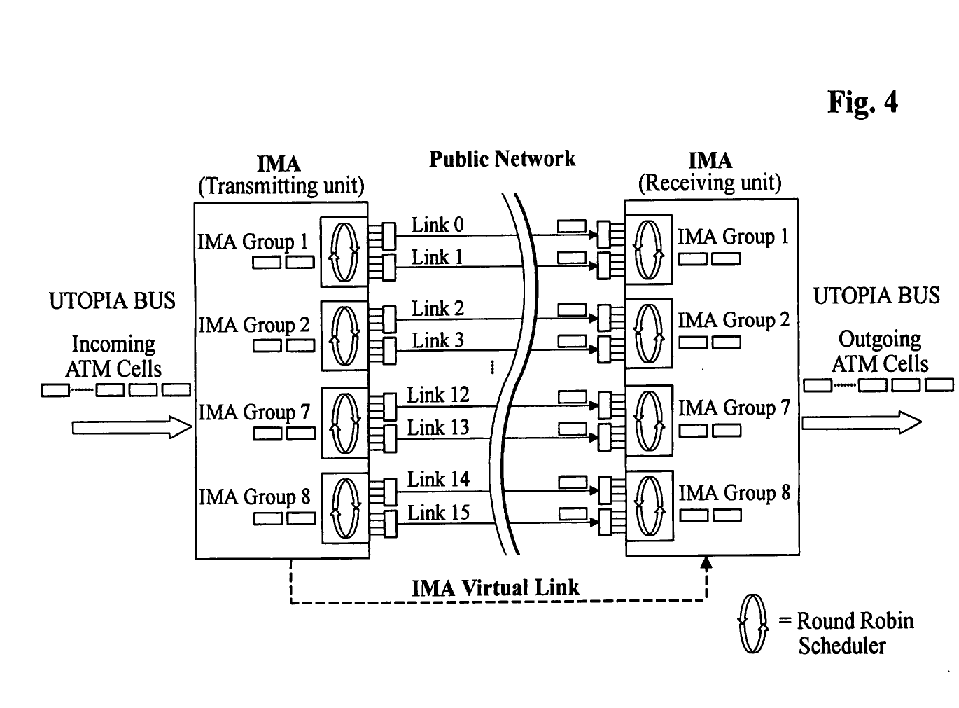

IMA processor 104 is connected to ATM multiplexer/demultiplexer 103 through a Utopia bus. IMA processor 104 receives the ATM cells from ATM multiplexer/demultiplexer 103, converts them into Pulse Code Modulation (PCM) packets, groups the PCM packets in a round-robin fashion (as shown in the IMA transmitting unit in FIG. 4), and outputs the grouped PCM packets to line interface unit 105. IMA processor 104 also converts the grouped PCM packets inputted from line interface unit 105 into ATM cells (as shown in the IMA receiving unit in FIG. 4) and outputs the converted ATM cells to ATM multiplexer/demultiplexer 103. Moreover, MA processor 104 monitors the status of the E1 or T1 link connected to line interface unit 105, and upon detection of an occurrence of a failure of the link, informs the operator of the occurrence of the failure.

Line interface unit 105 transmits the grouped PCM packets inputted from IMA processor 104 to general network 5 via the E1 or T1 line. Line interface unit 105 also outputs the grouped PCM packets inputted from general network 5 to IMA processor 104.

The operation of the router according to an embodiment of the present invention, as described above, will now be described with reference to FIGS. 2-4. The process at router 100, which receives data from the subscribers and routes them to general network 5, will be described first. First, CPU 102 receives a plurality of Ethernet packets from network processors 101 connected to the subscribers, converts them into ATM cells, and outputs the converted ATM cells to ATM multiplexer/demultiplexer 103. Then, ATM multiplexer/demultiplexer 103 multiplexes the plurality of ATM cells from CPU 102 to supply the multiplexed outputs to IMA processor 104. IMA processor 104 then converts the ATM cells from ATM multiplexer/demultiplexer 103 into Pulse Code Modulation (PCM) packets, groups the PCM packets in a round-robin fashion (as shown in the IMA transmitting unit in FIG. 4), and outputs the grouped PCM packets to line interface unit 105. Note that with the IMA scheme described above, ATM cells can be regrouped to prohibit the cells from being routed to a failed link (E1/T1), if any. Accordingly, the efficiency of network management can be improved. Line interface unit 105 transmits the grouped PCM packets inputted from IMA processor 104 to general network 5 via the E1 or T1 line.

Next, the process at router 100 of receiving data from the general network and routing the data to the subscribers is explained below with reference to FIG. 2. First, line interface unit 105 receives the grouped PCM data from general network 5 and outputs them to IMA processor 104. Then, the IMA processor receives the ATM cells from ATM multiplexer/demultiplexer 103, converts them to Ethernet data, and distributes the Ethernet data to network processor 101.

Meanwhile, ATM multiplexer/demultiplexer 103 demultiplexes the ATM cells inputted by IMA processor 104 and transmits the demultiplexed output to CPU 102. Then, CPU 102 converts the grouped PCM data from line interface unit 105 into ATM cells, and outputs the ATM cells to ATM multiplexer/demultiplexer 103.

Having described preferred embodiments of the present invention, it is to be understood that the present invention is not limited to the above-mentioned embodiments and that various changes and modifications can be effected therein by one skilled in the art without departing from the spirit or scope of the present invention.

### INDUSTRIAL APPLICABILITY

As described above, the router of the present invention incorporates both the CSU/DSU and IMA functions. As a result, the present invention provides the following advantageous effects. First, data services can be provided in a bandwidth broader than the E1/T1 bandwidth. Second, the architecture of the mobile communication network can be simplified so that the network can be constructed at a reduced cost. Further, convenience in the operation and maintenance of the network is provided at the same time.

1. A router for supporting an Inverse Multiplexing over ATM (IMA) function in a mobile communication network, said router comprising:
a CPU for converting into ATM cells from a plurality of Ethernet packets inputted from network processors connected to subscribers and outputting the converted ATM cells, and for converting into Ethernet packets from a plurality of ATM cells inputted from said CPU and distributing to the network processors the converted Ethernet packets;
an ATM multiplexer/demultiplexer connected to said CPU for multiplexing or demultiplexing the ATM cells;
an IMA processor connected to said ATM multiplexer/demultiplexer for converting into Pulse Code. Modulation (PCM) packets from ATM cells inputted from said ATM multiplexer/demultiplexer and grouping the PCM packets, and for converting into ATM cells from grouped PCM packets and outputting to said ATM multiplexer/demultiplexer the converted ATM cells; and
a line interface unit for transmitting to a general network the grouped PCM packets via a line (e.g., E1 or T1) and outputting to said IMA processor grouped PCM packets inputted from the general network.

2. The router according to claim 1, wherein said IMA processor monitors the status of the E1 or T1 link and, upon detection of an occurrence of a failure of the link, informs an operator of the occurrence of the failure.
